(19) United States
(12) Patent Application Publication
(10) Pub. No.: US 2024/0010759 A1
(43) Pub. Date: Jan. 11, 2024

(54) PROCESS TO PREPARE A SOLID SUPPORT FOR A PROCATALYST FOR POLYMERIZATION OF OLEFINS

(71) Applicant: SABIC GLOBAL TECHNOLOGIES B.V., BERGEN OP ZOOM (NL)

(72) Inventors: Akhlaq MOMAN, Riyadh (SA); Vladimir Aleksandrovich ZAKHAROV, Novosibirsk (RU); Sergei Andreevich SERGEEV, Novosibirsk (RU); Artem A. BARABANOV, Novosibirsk (RU)

(21) Appl. No.: 18/038,610

(22) PCT Filed: Nov. 25, 2021
(86) PCT No.: PCT/EP2021/082941

§ 371 Date: May 24, 2023

(30) Foreign Application Priority Data
Nov. 27, 2020 (EP) 20210486.5

(51) Int. Cl. C08F 4/50; C08F 110/06

(52) U.S. Cl. CPC C08F 4/50; C08F 110/06

(57) ABSTRACT

A process for the preparation of a solid support for a procatalyst for olefin polymerization includes: providing a compound R⁴_{z}MgX⁴_{2-z} wherein: R⁴ is independently a linear, branched or cyclic hydrocarbyl independently selected from alkyl, alkenyl, aryl, aralkyl, or alkylaryl groups, or combinations thereof; X⁴ is independently fluoride, chloride, bromide or iodide; and 0<z<2; and contacting the compound R⁴_{z}MgX⁴_{2-z} with a silane compound Si(OR⁵)₄₋ₙ(R⁶)ₙ to obtain a Mg(OR¹)ₓX¹₂₋ₓ wherein: R¹, R⁵ and R⁶ are each independently a linear, branched or cyclic hydrocarbyl independently selected from alkyl, alkenyl, aryl, aralkyl, alkoxycarbonyl or alkylaryl groups, or combinations thereof; X¹ is independently fluoride, chloride, bromide or iodide; 0<n<4; 0<z<2; and 0<x<2; wherein an initiator compound, which is a ketone, a diketone, an ester, a diester, and/or a benzamide, is added during step B to obtain a solid support.

### BACKGROUND

The present invention relates to an improved process to prepare a solid support for a procatalyst that is suitable for use in a catalyst system for polymerization of olefins using an initiator compound during said preparation. The invention also relates to said solid support obtained and a procatalyst and catalyst system comprising said solid support. In addition, the invention is related to a process of making polyolefins by contacting at least one olefin with said catalyst system. Moreover, the present invention relates to polymers obtained by polymerization using said procatalyst and to the shaped articles of said polymers.

Ziegler-Natta catalyst systems and their components that are suitable for preparing a polyolefin are generally known. An overview of such catalyst types is for example given by T. Pullukat and R. Hoff in Catal. Rev.—Sci. Eng. 41, vol. 3 and 4, 389-438, 1999. The preparation of such a procatalyst is for example disclosed in WO96/32427 A1. It is an object of the invention to provide an improved process for a solid support for a procatalyst for polymerization of olefins, especially with improved yield and xylene solubles.

### SUMMARY

At least one of the aforementioned objects of the present invention is achieved with the several aspects discussed below.

In a first aspect, the invention relates to a process for the preparation of a solid support for a procatalyst suitable for preparing a catalyst composition for olefin polymerization, said process comprising:
step A) providing or preparing a compound R⁴_{z}MgX⁴_{2-z} wherein: R⁴ is independently selected from linear, branched or cyclic hydrocarbyl group independently selected from alkyl, alkenyl, aryl, aralkyl, or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; X⁴ is independently selected from the group consisting of fluoride (F—), chloride (Cl—), bromide (Br—) or iodide (I—), preferably chloride; and z is in a range of larger than 0 and smaller than 2, being 0<z<2; and step B) contacting the compound R⁴_{z}MgX⁴_{2-z} with a silane compound Si(OR⁵)₄₋ₙ(R⁶)ₙ to give a Mg(OR¹)ₓX¹₂₋ₓ wherein: R¹, R⁵ and R⁶ are each independently selected from linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X¹ is independently selected from the group consisting of fluoride (F—), chloride (Cl—), bromide (Br—) or iodide (I—), preferably chloride; n is in range of 0 to 4, preferably n is from 0 up to and including 1; z is in a range of larger than 0 and smaller than 2, being 0<z<2; and x is in a range of larger than 0 and smaller than 2, being 0<x<2;
wherein an initiator compound, selected from the group consisting of a ketone, a diketone, an ester, a diester and a benzamide, is added during step B;
to obtain a solid support
wherein the initiator compound does not contain any heteroatom, nor is a phthalates.

According to another aspect the invention is related to a solid support or activated solid support directly obtained by or obtainable by the process according the inventive processes.

According to yet another aspect the invention is related to a process for the preparation of a procatalyst suitable for preparing a catalyst composition for olefin polymerization, said process comprising: I) providing a solid support or activated solid support according to the invention; and II) reacting said solid support or activated solid support with a halogen-containing Ti-compound, optionally an activator prior to or simultaneous with the addition of an internal donor, and at least one internal electron donor to obtain said procatalyst.

According to yet another aspect the invention is related to a procatalyst that is directly obtained by or obtainable by the process according to the previous aspect.

According to yet another aspect the invention is related to a solid support or activated solid support having an average particle size (or APS) of between 8-35 microns, preferably 11 to 32, more preferably 18 to 30.

According to yet another aspect the invention is related to a catalyst system comprising the inventive procatalyst, a co-catalyst and optionally an external electron donor.

According to yet another aspect the invention is related to a process for the preparation of polyolefins comprising the contacting of the catalyst system of the invention with at least one olefin, preferably a propylene to prepare polypropylene homopolymer or a mixture of propylene and an olefin, such as ethylene, butene or hexene, to prepare a propylene-olefin copolymer.

According to yet another aspect the invention is related to a polyolefin, preferably a polypropylene, obtainable by the process according to the previous aspect.

According to yet another aspect the invention is related to a shaped article comprising the polyolefin, preferably polypropylene, according to the invention.

### Definitions

The following definitions are used in the present description and claims to define the stated subject matter. Other terms not cited below are meant to have the generally accepted meaning in the field.

“Ziegler-Natta catalyst” as used in the present description means: a transition metal-containing solid catalyst compound comprises catalytic species supported on a metal or metalloid compound (e.g. a magnesium compound or a silica compound).

“catalytic species” as used in the present description means: a transition metal-containing species comprises a transition metal halide selected from titanium halide, chromium halide, hafnium halide, zirconium halide and vanadium halide.

“internal donor” or “internal electron donor” as used in the present description means: an electron-donating compound containing one or more atoms of oxygen (O) and/or nitrogen (N).

“external donor” or “external electron donor” as used in the present description means: an electron-donating compound used as a reactant in the polymerization of olefins. It comprises at least one functional group that is capable of donating at least one pair of electrons to a metal atom.

“initiator compound” as used in the present description means: a compound which is added during the synthesis of the solid support for the procatalyst.

“activator” as used in the present description means: an electron-donating compound containing one or more atoms of oxygen (O) and/or nitrogen (N) which is used during the synthesis of the procatalyst (viz. during the addition of the catalytic species to the solid support) and is added prior to or simultaneous with the addition of an internal donor.

“activating compound” as used in the present description means: a compound used to activate the solid support prior to contacting said solid support with the catalytic species. This is different from said initiator compound since this activating compound is used after the solid support has been prepared and prior to the addition of the catalytic species.

“procatalyst” as used in the present description have the same meaning: a component of a catalyst composition generally comprising an (activated) solid support, a transition metal-containing catalytic species, and one or more internal donors.

“halide” or “halogen” as used in the present description means: an ion selected from the group of: fluoride (F—), chloride (Cl—), bromide (Br—) or iodide (I—).

“Heteroatom” as used in the present description means: an atom other than carbon or hydrogen. However, as used herein—unless specified otherwise, such as below,—when “one or more hetereoatoms” is used one or more of the following is meant: F, Cl, Br, I, N, O, P, B, S or Si. Thus a heteroatom also includes halides.

“hydrocarbyl” as used in the present description means: is a substituent containing hydrogen and carbon atoms, or linear, branched or cyclic saturated or unsaturated aliphatic radical, such as alkyl, alkenyl, and alkynyl; alicyclic radical, such as cycloalkyl, cycloalkenyl; aromatic radical, such as monocyclic or polycyclic aromatic radical, as well as combinations thereof, such as alkaryl and aralkyl. A hydrocarbyl group may be substituted with one or more non-hydrocarbyl substituent groups. A non-limiting example of a non-hydrocarbyl substituent is a heteroatom. Examples are alkoxycarbonyl (viz. carboxylate) groups. When in the present description “hydrocarbyl” is used it can also be “substituted hydrocarbyl”, unless stated otherwise.

“alkyl” as used in the present description means: an alkyl group being a functional group or side-chain consisting of carbon and hydrogen atoms having only single bonds. An alkyl group may be straight or branched and may be un-substituted or substituted.

“aryl” as used in the present description means: an aryl group being a functional group or side-chain derived from an aromatic ring. An aryl group and may be un-substituted or substituted with straight or branched hydrocarbyl groups.

“alkoxide” or “alkoxy” as used in the present description means: a functional group or side-chain obtained from an alkyl alcohol. It consists of an alkyl bonded to a negatively charged oxygen atom.

“aryloxide” or “aryloxy” or “phenoxide” as used in the present description means: a functional group or side-chain obtained from an aryl alcohol. It consists of an aryl bonded to a negatively charged oxygen atom.

“Grignard reagent” or “Grignard compound” as used in the present description means: a compound or a mixture of compounds of formula R⁴_{z}MgX⁴_{2-z} (R⁴, z, and X⁴ are as defined below) or it may be a complex having more Mg clusters, e.g. R₄Mg₃Cl₂.

“bulk density” or “BD” as used in the present description means: the weight per unit volume of a material, including voids inherent in the material as tested. Bulk density is measured as apparent density according to ASTM D1895-96 Reapproved 2010-e1, test method A.

“XS” or “xylene soluble fraction” as used in the present description means: the weight percentage (wt. %) of soluble xylene in the isolated polymer, measured according to ASTM D 5492-10.

“yield” as used in the present description means: the amount of kilograms of polymer produced (product rate) per gram of procatalyst consumed in the polymerization reactor per hour.

“yield per Ti” as used in the present description means: the yield of PP (in kg) divided by the amount of titanium in 1 gram of procatalyst. For example: 12.2 kg PP/g cat with a Ti=1.8 wt. % corresponds to a yield of 12.2 kg PP/0.018=678 kg PP/g Ti).

“Particle size” as used in the present description means the average particle size (APS) of the solid support or the procatalyst. It is measured using a test method based on ASTM standard test method D4464-201.

“SPAN” as used in the present description means the particle size distribution (PSD) of the solid support of the procatalyst or the polymer. It is calculated according to the following formula: SPAN=(D90-D10)/D50. The particle size distribution and the average size of support, procatalyst and PP powder were determined by laser light scattering on Mastersizer 2000 instrument.

### DETAILED DESCRIPTION OF INVENTION AND EMBODIMENTS

It has been surprisingly found that the properties of the procatalyst can be improved by an improved method for preparing a solid support for said procatalyst according to the first aspect of the present invention. The use of an initiator compound added during the synthesis of the support has shown to increase the yield and decrease the xylene solubles value of the final polymer obtained. Moreover, a decrease of the D50 was observed as well as an increase of the pore volume of the solid support.

In addition, it was found that several classes of initiator compounds considered (ketones, esters and benzamides) provides additional advantages, such as a decrease in the bulk density for ester compounds and benzamide compounds and an increase in the pore volume of the procatalyst for the ester compounds.

Accordingly the initiator compound is selected from the group consisting of a ketone, a diketone, an ester, a diester and a benzamide, wherein the initiator compound does not contain any heteroatom, nor is a phthalate.

In an embodiment as initiator compound a ketone compound represented by Formula I or a diketone represented by Formula II is used,

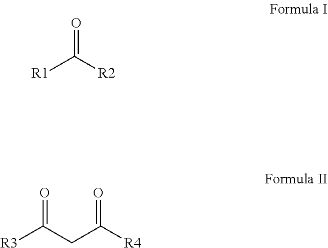

wherein R1, R2, R3, and R4 are each independently a linear, branched or cyclic hydrocarbyl group, which hydrocarbyl group is independently selected from alkyl, alkenyl, aryl, aralkyl, and one or more combinations thereof, preferably as initiator compound a ketone is used selected from a the group consisting of methyl isobutyl ketone, acetophenone, methyl propyl ketone, di-isopropyl ketone, acetone and acetyl acetone. Methyl isobutyl ketone, acetophenone, methyl propyl ketone, di-isopropyl ketone, and acetone are according to Formula I and acetyl acetone is according to Formula II.

Preferably, each R1, R2, R3 and R4 groups are C1-C12, more preferably C1-C6 groups. Preferably R1 is an alkyl group (preferably C1-C6) and R2 is an alkyl group (preferably C1-C6) or an aryl group (preferably C6).

In an embodiment, as initiator compound a mono ester represented by Formula III or a diester represented by Formulas IV, V and VI,

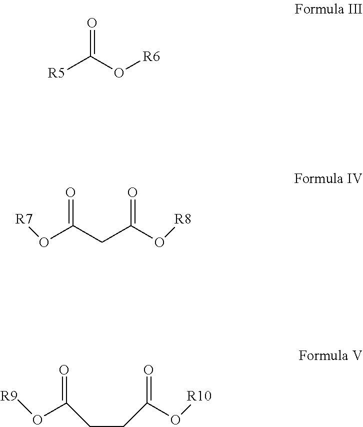

wherein R5, R6, R7, R8, R9 and R10 are each independently a linear, branched or cyclic hydrocarbyl group, which hydrocarbyl group is independently selected from alkyl, alkenyl, aryl, aralkyl, and one or more combinations thereof, preferably said initiator is selected from a the group consisting of butyl acetate, ethyl acetate, ethyl benzoate, diethylmalonate, and diethylsuccinate. Butyl acetate, ethyl acetate, and ethyl benzoate are according to Formula III, diethylmalonate is according to Formula IV, diethylsuccinate is according to Formula V. Preferably, each R5, R6, R7, R8, R9, and R10 groups are C1-C12, more preferably C1-C6 groups. Preferably R5 is methyl (C1).

In an embodiment, as an initiator compound an amide represented by Formula VII is used

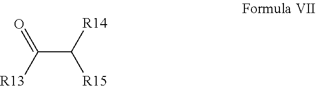

wherein R13, R14, and R15 are each independently selected linear, branched or cyclic hydrocarbyl group, which hydrocarbyl group is independently selected from alkyl, alkenyl, aryl, aralkyl, and one or more combinations thereof, preferably as initiator compound an benzamide is used selected from a the group consisting of N,N-dimethyl benzamide is used.

In an embodiment, said solid support obtained is activated using an activating electron donor and/or an activating compound. Preferably as activating electron donor an alkyl alcohol is used, such as methanol or ethanol being more preferred. Preferably as activating compound metal alkoxide such as titanium tetraethoxide being more preferred. Preferably ethanol and/or titanium tetraethoxide, more preferably ethanol, to obtain an activated solid support.

In an embodiment, the initiator may be:
methyl isobutyl ketone (MIBK), in which R1 is isobutyl (C4) and R2 is methyl (C1),
acetophenone (AcPh), in which R1 is phenyl (C6) and R2 is methyl (C1),
methyl propyl ketone (MPK), in which R1 is n-propyl (C3) and R2 is methyl (C1),
di-isopropyl ketone (DIPK), in which R1 is isopropyl (C3) and R2 is isopropyl (C3),
acetone (Ac), in which R1 is methyl (C1) and R2 is methyl (C1),
acetyl acetone (AcAc), in which R3 is methyl (C1) and R4 is methyl (C1),
butyl acetate (BuAc), in which R5 is methyl (C1) and R6 is n-butyl (C4),
ethyl acetate (EA), in which R5 is methyl (C1) and R6 is ethyl (C2),
ethyl benzoate (EB), in which R5 is phenyl (C6) and R6 is ethyl (C2),
diethylmalonate (DEM), in which R7 is ethyl (C2) and R8 is ethyl (C2),
diethylsuccinate (DES), in which R9 is ethyl (C2) and R10 is ethyl (C2),
N,N-dimethyl benzamide, in which R13 is phenyl (C6) and R14 and R15 are both methyl (C1),
dimethylmalonate (DMM), in which R7 is methyl (C2) and R8 is methyl (C2),
dimethylsuccinate (DMS), in which R9 is methyl (C2) and R10 is methyl (C2),

A process disclosing an activation of a regular solid support is described in detail in WO2015091984 A1 of the same applicant, page 23 line 3 to page 28, line 14, which complete section is incorporated here by reference.

In another aspect the invention relates to the solid support or activated solid support that is directly obtained by or obtainable by the process according to the first aspect.

In another aspect, the present invention relates to a process for the preparation of a procatalyst suitable for preparing a catalyst composition for olefin polymerization, said process comprising:
I) providing a solid support or activated solid support according to the invention; and
II) reacting said solid support or activated solid support with a halogen-containing Ti-compound, optionally an activator prior to or simultaneous with the addition of an internal donor, and at least one internal electron donor to obtain said procatalyst.

Accordingly suitable internal electron donor are an electron-donating compound containing one or more atoms of oxygen (O) and/or nitrogen (N) for example, the internal electron donor may be:
9,9-bis(methoxymethyl)fluorene (Flu).
4-[(ethoxycarbonyl)-(methyl)amino]pentan-2-yl ethyl carbamate (AB-OEt)
4-[benzoyl(methyl)-amino]pentan-2-yl benzoate (AB)
Isopropylisopentyldimethoxypropane (IPIPEN)
Di-n-butyl-phthalate (DBP)

In an embodiment of said process for preparing a procatalyst during II) as activator and internal electron donor are added:
N,N-dimethyl benzamide (BA-2Me) as activator and 9,9-bis(methoxymethyl)fluorene (Flu) as internal donor; or
ethyl benzoate (EB) as activator and 4-[(ethoxycarbonyl)-(methyl)amino]pentan-2-yl ethyl carbamate (AB-OEt) or 4-[benzoyl(methyl)-amino]pentan-2-yl benzoate (AB) as internal donor; or
N,N-dimethyl benzamide (BA-2Me) as activator and Isopropylisopentyldimethoxypropane (IPIPEN) as internal donor.

In the claims, the word “comprising” does not exclude other elements or steps, and the indefinite article “a” or “an” does not exclude a plurality. The foregoing description provides embodiments of the invention by way of example only. The scope of the present invention is defined by the appended claims. One or more of the objects of the invention are achieved by the appended claims.

### EXAMPLES

The present invention is further elucidated based on the Examples below which are illustrative only and not considered limiting to the present invention.

I) Dosage Regime of IC: Premixing of Grignard and Silane Compounds, Dosing Temperature of 0° C., Dosing Time 2 Hours

### Example 1 (E1)

### Summary

This example makes use of a butyl Grignard compound for the solid support. The support is not activated. As initiator compound an ester compound (di-ester, di butyl phthalate or DBP) is used and as an internal donor the same ester di butyl phthalate is used. Step B is carried out at a mole ratio DBP/Mg of 0.1, a dosing temperature for the DBP of 0° C. and a dosing time of the DBP of 2 hours.

Step A) Preparation of the Grignard Compound

This step was carried out according to the procedure presented in Example III of EP 1 222 214 B1, but in large scale. A stainless steel reactor of 16 l volume was filled with magnesium powder 280 g. The reactor was brought under nitrogen. The magnesium was heated at 80° C. for 1 hour, after which a mixture of dibutyl ether (DBE, 1.5 l) and n-chlorobutane (80 ml) was added. The temperature was raised to 75° C. and iodine (0.7 g) was added to the reaction mixture. After the colour of the iodine had disappeared, a mixture of dibutyl ether (10 l) and n-chlorobutane (1.1 l) was slowly added for 3 hour. The temperature of reaction mixture was kept in interval 76-78° C.

The reaction mixture was stirred for another 4 hours at 76° C. Then the stirring and heating were stopped and the solid material was allowed to settle for 48 hours. By decanting the solution above the precipitate, the solution of butylmagnesiumchloride in dibutyl ether (product A) with a concentration of 0.86 mol Mg/I was obtained in this step.

Step B) Preparation of the Support+Addition of IC

This step was carried out according to the procedure presented in Example I of EP 1 222 214 B1, except that during the dosing of the components a dibutyl phthalate solution was additionally dosed into the reactor. 250 ml of dibutyl ether was introduced to a 1.5 liter reactor. The reactor was fitted by propeller stirrer. The reactor was thermostated at 0° C.

The solution of the product A obtained on step A (240 ml, 0.206 mol Mg) and solution of tetraethoxysilane in DBE (30.4 ml of TES+88.6 ml of DBE; Si/Mg=0.66) were cooled to 5° C., and then were dosed simultaneously into reactor throughout mixing device with volume 0.45 ml supplied with a jacket. Dosing time was 120 min. Mixing device (minimixer) was cooled to 5° C. by means of cold water circulating in the device jacket. The contact time of reagents (product A and TES) was 14 s in the minimixer and the connecting tube between the minimixer and the reactor. Simultaneously the solution of dibutyl phthalate (DBP) in DBE (5.5 ml of dibutyl phthalate and 34.5 ml of DBE; mole ratio DBP/Mg=0.1) were dosed to reactor through a separate tube during 120 min. The stirring speed in the reactor was 350 rpm at the beginning of dosing and was gradually increased up to 425 rpm at the end of dosing stage.

After completion of the dosing the reaction mixture was heated up to 60° C. during 120 min and kept at this temperature for 1 hour. Then the stirring was stopped and the solid product was allowed to settle. The supernatant was removed by decanting. The solid substance was washed three times using 900 ml of heptane. As a result the about 30 g of solid product B was obtained, suspended in heptane.

Step C) Activation of the Support

The support is not activated

Step D) Preparation of the Procatalyst

A glass reactor with volume 0.3 l was brought under nitrogen and 125 ml of titanium tetrachloride was added into reactor. The suspension, containing c.a. 6 g of the solid product B in 15 ml of heptane, was added into reactor under stirring. Then the reaction mixture was heated up to 100° C. during 1 hour and after that 1.6 ml of dibutyl phthalate was added into reactor (DBP/Mg=0.15). Then the reaction mixture was heated up to 115° C. and kept at 115° C. for 105 min. Then the stirring was stopped and the solid product was allowed to settle. The supernatant was removed by decanting, after which the solid product was washed with chlorobenzene (125 ml) at 100° C. for 20 min. Then the washing solution was removed by decanting, after which a mixture of titanium tetrachloride (62.5 ml) and chlorobenzene (62.5 ml) was added. The reaction mixture was kept at 115° C. for 30 min, after which the solid product was allowed to settle, and the last treatment was repeated once again. The solid product obtained was washed five times using 150 ml of heptane at 60° C., solid procatalyst, suspended in heptane, was obtained.

Step E) Polymerization of Propylene

Polymerization of propylene was carried out in a stainless steel reactor (with a volume of 0.7 l) in heptane (300 ml) at a temperature of 70° C., total pressure 0.7 MPa and hydrogen presence (55 ml) for 1 hour in the presence of a procatalyst system comprising the procatalyst component according to step C, triethylaluminium and cyclohexylmethyldimethoxysilane (c-donor). The concentration of the procatalyst component was 0.033 g/l; the concentration of triethylaluminium was 4.0 mmol/l and the concentration of c-donor was 0.2 mmol/l. Data on the procatalyst performance at the propylene polymerization are presented in Table 1.

### Example 2 (E2)

### Summary

This example makes use of a butyl Grignard compound for the solid support. The support is activated. As initiator compound an ester compound (di-ester, di butyl phthalate or DBP) is used and as an internal donor the same ester di butyl phthalate is used. This is similar to Example 1, the only difference being that step C) is carried out and that in step D) the activated support was used. Step B is carried out at a mole ratio DBP/Mg of 0.1, a dosing temperature for the DBP of 0° C. and a dosing time of the DBP of 2 hours.

Step C) Activation of the Support

Then we have done additional stage of support activation via treatment of product B with ethanol according to procedure proposed in EP 1661917A1. The 0.31 glass flask equipped with a mechanical agitator was filled with a slurry of 6 g of product B dispersed in 100 ml of heptane in inert nitrogen atmosphere at 0° C. Subsequently a solution of 0.96 ml ethanol in 20 ml of heptane was added at 0° C. for 1 hour, resulting in a ratio ethanol/Mg=0.4. After that the slurry was slowly heated to 30° C. in 90 min and kept at that temperature for another 2 hours. Finally the supernatant liquid was decanted from the solid reaction product, which was washed once with 150 ml of heptane at 30° C. As a result the product C (activated support) was obtained, suspended in 15 ml of heptane.

### Example 3 (E3)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is not carried out. Step B is discussed below. Step B is carried out at a mole ratio EB/Mg of 0.1, a dosing temperature for the EB of 0° C. and a dosing time of the EB of 2 hours.

Step B) Preparation of the Support+Addition of IC

Preparation of the product B (support) was carried out as described in Example 1 except that during the dosing of the components a ethyl benzoate solution (2.96 ml of ethyl benzoate (0.1 EB/Mg) and 37 ml of DBE) was additionally dosed into the reactor instead of dibutyl phthalate solution.

### Example 4 (E4)

### Summary

This example makes use of a butyl Grignard compound for the solid support. The support is activated. As initiator compound an ester compound (mono-ester, ethyl benzoate or EB) is used and as an internal donor di butyl phthalate is used. Steps A), D) and E) were carried as described in Example 1. Step C) is carried out as in Example 2. Step B is carried out as in Example 3. Step B is carried out at a mole ratio EB/Mg of 0.1, a dosing temperature for the EB of 0° C. and a dosing time of the EB of 2 hours.

### Example 5 (E5)

### Summary

This example makes use of a butyl Grignard compound for the solid support. The support is not activated. As initiator compound a ketone compound (mono-ketone, methyl isobutyl ketone or MIBK) is used and as an internal donor di butyl phthalate is used. Steps A), D) and E) were carried as described in Example 1. Step C) is not carried out. Step B is carried out as disclosed below. Step B is carried out at a mole ratio MIBK/Mg of 0.1, a dosing temperature for the MIBK of 0° C. and a dosing time of the MIBK of 2 hours.

Step B) Preparation of the Support+Addition of IC

Preparation of the product B (support) was carried out as described in Example 1 except that methylisobutylketone was used instead of dibutyl phthalate (2.58 ml methylisobutylketone (MIBK) and 47 ml of DBE; mole ratio MIBK/Mg=0.1).

### Example 6 (E6)

### Summary

This example makes use of a butyl Grignard compound for the solid support. The support is not activated. As initiator compound a ketone compound (di-ketone, acetyl acetone or AcAc) is used and as an internal donor di butyl phthalate is used. Steps A), D) and E) were carried as described in Example 1. Step C) is not carried out. Step B is carried out as disclosed below. Step B is carried out at a mole ratio AcAc/Mg of 0.1, a dosing temperature for the AcAc of 0° C. and a dosing time of the AcAc of 2 hours.

Step B) Preparation of the Support+Addition of IC

Preparation of the product B (support) was carried out as described in Example 1 except that acetylacetone was used instead of dibutyl phthalate (2.1 ml acetylacetone (AcAc) and 47 ml of DBE; mole ratio AcAc/Mg=0.1).

### Example 7 (E7)

### Summary

This example makes use of a butyl Grignard compound for the solid support. The support is activated. As initiator compound a ketone compound (di-ketone, acetyl acetone or AcAc) is used and as an internal donor di butyl phthalate is used. Steps A), D) and E) were carried as described in Example 1. Step C) is carried out as in Example 2. Step B is carried out as in Example 23. Step B is carried out at a mole ratio AcAc/Mg of 0.1, a dosing temperature for the Ac of 0° C. and a dosing time of the Ac of 2 hours.

### Example 8 (E8)

### Summary

This example makes use of a butyl Grignard compound for the solid support. The support is not activated. As initiator compound a ketone compound (mono-ketone, methyl propyl ketone or MPK) is used and as an internal donor di butyl phthalate is used. Steps A), D) and E) were carried as described in Example 1. Step C) is not carried out. Step B is carried out as disclosed below. Step B is carried out at a mole ratio MPK/Mg of 0.1, a dosing temperature for the IC of 0° C. and a dosing time of the MPK of 2 hours.

Step B) Preparation of the Support+Addition of IC

Preparation of the product B (support) was carried out as described in Example 1 except that methyl propyl ketone was used instead of dibutyl phthalate (2.2 ml methyl propyl ketone (MPK) and 48 ml of DBE; mole ratio MPK/Mg=0.1).

### Example 9 (E9)

### Summary

This example makes use of a butyl Grignard compound for the solid support. The support is activated. As initiator compound a ketone compound (mono-ketone, methyl propyl ketone or MPK) is used and as an internal donor di butyl phthalate is used. Steps A), D) and E) were carried as described in Example 1. Step C) is carried out as in Example 2. Step B is carried out as in Example 8. Step B is carried out at a mole ratio MPK/Mg of 0.1, a dosing temperature for the MPK of 0° C. and a dosing time of the MPK of 2 hours.

### Example 10 (E10)

### Summary

This example makes use of a butyl Grignard compound for the solid support. The support is not activated. As initiator compound a ketone compound (mono-ketone, di isopropyl ketone DIPK) is used and as an internal donor di butyl phthalate is used. Steps A), D) and E) were carried as described in Example 1. Step C) is not carried out. Step B is carried out as disclosed below. Step B is carried out at a mole ratio DIPK/Mg of 0.1, a dosing temperature for the DIPK of 0° C. and a dosing time of the DIPK of 2 hours.

Step B) Preparation of the Support+Addition of IC

Preparation of the product B (support) was carried out as described in Example 1 except that diisopropyl ketone was used instead of dibutyl phthalate (2.35 g diisopropyl ketone (DIPK) and 48 ml of DBE; mole ratio DIPK/Mg=0.1).

### Example 11 (E11)

### Summary

This example makes use of a butyl Grignard compound for the solid support. The support is activated. As initiator compound a ketone compound (mono-ketone, di isopropyl ketone DIPK) is used and as an internal donor di butyl phthalate is used. Steps A), D) and E) were carried as described in Example 1. Step C) is carried out as in Example 2. Step B is carried out as in Example 10. Step B is carried out at a mole ratio DIPK/Mg of 0.1, a dosing temperature for the DIPK of 0° C. and a dosing time of the DIPK of 2 hours.

### Example 12 (E12)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is not carried out. Step B is carried out as described in Example 3 except that during the dosing of the components 5.92 ml of ethyl benzoate were used instead of 2.96 ml (5.92 ml of EB and 34 ml of DBE, mole ratio EB/Mg=0.2). Step B is carried out at a mole ratio EB/Mg of 0.2, a dosing temperature for the EB of 0° C. and a dosing time of the EB of 2 hours.

### Example 13 (E13)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is not carried out. Step B is carried out as described in Example 12 except that during the dosing of the components 1.48 ml of ethyl benzoate were used (1.48 ml of EB and 38.5 ml of DBE, mole ratio EB/Mg=0.05). Step B is carried out at a mole ratio EB/Mg of 0.05, a dosing temperature for the EB of 0° C. and a dosing time of the EB of 2 hours.

### Example 14 (E14)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is not carried out. Step B is carried out as described in Example 12 except that during the dosing of the components 0.74 ml of ethyl benzoate were used (0.74 ml of EB and 39 ml of DBE, mole ratio EB/Mg=0.025). Step B is carried out at a mole ratio EB/Mg of 0.025, a dosing temperature for the EB of 0° C. and a dosing time of the EB of 2 hours.

### Example 15 (E15)

### Summary

This example makes use of a butyl Grignard compound for the solid support. The support is not activated. As initiator compound an ester compound (di-ester, di butyl phthalate or DBP) is used and as an internal donor di butyl phthalate is used. Steps A), D) and E) were carried as described in Example 1. Step C) is not carried out. Step B is carried out as described in Example 1 except that during the dosing of the components 22 ml of dibutyl phthalate were used instead of 5.5 ml (22 ml of dibutyl phthalate and 18 ml of DBE; mole ratio DBP/Mg=0.4). Step B is carried out at a mole ratio DBP/Mg of 0.4, a dosing temperature for the DBP of 0° C. and a dosing time of the DBP of 2 hours.

### Comparative Example 1 (CE1)

### Summary

This example makes use of a butyl Grignard compound for the solid support. The support is not activated. No initiator compound was used. As internal donor an ester compound (di-ester, di butyl phthalate or DBP) is used in a ratio DBP/Mg of 0.15. Steps A), D) and E) were carried out as described in Example 1, step C was not carried out.

Step B) is discussed below.

Step B) Preparation of the Support

Preparation of the solid product B (support) was carried out as described in Example 1, except that dosing of a solution of dibutyl phthalate was not used, that is, the procedure of support syntheses was close to Example I of EP 1 222 214 E1.

### Comparative Example 2 (CE2)

### Summary

This example makes use of a butyl Grignard compound for the solid support. The support is not activated. No initiator compound was used. As internal donor an ester compound (di-ester, di butyl phthalate or DBP) is used in a ratio DBP/Mg of 0.2. Steps A), D) and E) were carried out as described in Example 1, step C was not carried out.

Step B) is discussed below.

Step B) Preparation of the Support

Preparation of the solid product B (support) was carried out as described in Example 1, except that dosing of a solution of dibutyl phthalate was not used, that is, the procedure of support syntheses was close to Example I of EP 1 222 214 B1.

### Comparative Example 3 (CE3)

### Summary

This example makes use of a butyl Grignard compound for the solid support. The support is not activated. No initiator compound was used. As internal donor an ester compound (di-ester, di butyl phthalate or DBP) is used in a ratio DBP/Mg of 0.25. Steps A), D) and E) were carried out as described in Example 1, step C was not carried out.

Step B) is discussed below.

### Step B) Preparation of the Support

Preparation of the solid product B (support) was carried out as described in Example 1, except that dosing of a solution of dibutyl phthalate was not used, that is, the procedure of support syntheses was close to Example I of EP 1 222 214 B1.

### Comparative Example 4 (CE4)

### Summary

This example makes use of a butyl Grignard compound for the solid support. The support is activated. No initiator compound was used. As internal donor an ester compound (di-ester, di butyl phthalate or DBP) is used. Steps A), D) and E) were carried out as described in Example 1, step C was carried out according to Example 2. Step B) was carried out as in Comparative Example 1.

TABLE 1
Examples using a dosing temperature of 0° C. and
time of 2 hours during step B using DBP as internal donor*

| | | IC | Act. | | | | Yield | | |
|---|---|---|---|---|---|---|---|---|---|
| Ex | Form# | [IC/Mg] | Sup. | SPAN | Ti | Yield | per Ti | XS | BD |
| E1 | VI | DBP[0.1] | No | 0.45 | 1.8 | 12.2 | 678 | 1.5 | 430 |
| E2 | VI | DBP[0.1] | Yes | 0.61 | 1.8 | 15.8 | 878 | 1.7 | 415 |
| E3 | III | EB[0.1] | No | 0.75 | 1.4 | 12.0 | 857 | 0.4 | 460 |
| E4 | III | EB[0.1] | Yes | 0.57 | 1.5 | 14.4 | 960 | 0.4 | 435 |
| E5 | I | MIBK[0.1] | No | 0.50 | 1.3 | 6.5 | 500 | 1.7 | 476 |
| E6 | II | AcAc[0.1] | No | 0.50 | 2.1 | 8.0 | 381 | 1.8 | 302 |
| E7 | II | AcAc[0.1] | Yes | 0.40 | 1.5 | 10.9 | 727 | 1.5 | 309 |
| E8 | I | MPK[0.1] | No | 0.9 | 1.5 | 12.6 | 840 | 1.6 | 455 |
| E9 | I | MPK[0.1] | Yes | 0.9 | 1.6 | 14.4 | 900 | 2.1 | 464 |
| E10 | I | DIPK[0.1] | No | 0.6 | 1.5 | 11.4 | 760 | 1.9 | 463 |
| E11 | I | DIPK[0.1] | Yes | 0.6 | 1.6 | 15.4 | 963 | 2.3 | 456 |
| E12 | III | EB[0.2] | No | 0.5 | 1.5 | 11.0 | 733 | 1.9 | n.d. |
| E13 | III | EB[0.05] | No | 0.9 | 1.4 | 8.9 | 636 | 1.4 | n.d. |
| E14 | III | EB[0.025] | No | 0.3 | 1.6 | 7.5 | 469 | 1.8 | n.d. |
| E15 | VI | DBP[0.4] | No | 1.9 | 1.4 | 11.5 | 821 | 2.4 | n.d. |
| CE1 | — | None | No | 0.50 | 1.4 | 6.5 | 464 | 2.4 | 440 |
| CE2 | — | None | No | 0.50 | 1.4 | 5.7 | 407 | 2.6 | 440 |
| CE3 | — | None | No | 0.50 | 1.3 | 5.1 | 392 | 2.9 | 430 |
| CE4 | — | none | Yes | 0.55 | 1.9 | 11.8 | 621 | 2.2 | 425 |

SPAN = (D90 − D10)/D50
Ti = titanium content of procatalyst in wt. % based on the total weight of the procatalyst
Yield = activity (yield of PP in kilograms per gram of procatalyst in 1 hour) used during
polymerization
Yield per Ti = yield of PP per gram of Ti in procatalyst
XS = value for xylene solubles in wt. % based on the total weight of the polymer obtained
BD = bulk density in gram per liter

| | | IC | Act. | | | | |
|---|---|---|---|---|---|---|---|
| Ex. | Form# | [IC/Mg] | Sup. | PVs | SAss | PVp | SAp |
| E1 | VI | DBP[0.1] | No | 0.006 | 5.8 | 0.24 | 185 |
| E15 | VI | DBP[0.4] | No | n.d. | n.d. | n.d. | n.d. |
| E3 | III | EB[0.1] | No | 0.006 | 4.4 | 0.22 | 207 |
| CE1 | — | None | No | <0.001 | <0.5 | 0.18 | 174 |

*PVss = Pore volume of the solid support (VΣ) in cm³ per gram of the support
PVp = Pore volume of the procatalyst (VΣ) in cm³ per gram of the support
SAss = Surface area of the solid support (S_{BET}) in m² per gram of the support
SAp = Surface area of the procatalyst (S_{BET}) in m² per gram of the support

The tables above clearly show that both for the non-activated supports as for the activated support the present invention (addition of IC during support synthesis) achieves at least one of the following: i) an increase in yield, ii) an increase in yield per wt. % of titanium; iii) an increase in the pore volume and surface area of the solid support; iv) an increase in the pore volume and surface area of the resulting procatalyst.

By the addition of the initiator compound in Example 1, the ratio of DBP to Mg is increased from 0.15 to 0.25 (0.1 during step B as initiator compound and 0.15 during step D as internal electron donor). To review if the positive effects where not obtained purely because of the increase in amount of DPB but actually by the pre-dosing of DBP in the form of initiator compound, comparative examples 2 and 3 (CE2 and CE3) were carried out having a DBP/Mg of 0.2 and 0.25 wherein the full dose of DBP is as internal electron donor during step D. The result of an increase in the amount of DBP was a decrease in activity by 20-30% and a deterioration in stereospecificity compared to the optimal DBP/Mg=0.15. Without wishing to be bound by a particular theory, the present inventors believe that because DBP (and the other ICs) contain a carboxyl group, that carboxyl group will interact with BuMgCl and is converted into derivatives of secondary and tertiary alcohols. In the final procatalyst obtained, the initiator compound as such is no longer present, instead it is converted when carrying out is initiating action.

To study the optimal IC/Mg ratio used during step B several tests were carried out. When Example 15 is compared to Example 1 (and when both are compared to CE1), it is clear that when increasing the IC/Mg ratio from 0.1 to 0.4 the overall yield drops and the XS increases to the same level as no IC present. Hence an IC/Mg ratio of 0.1 is preferred over 0.4. When Example 12 is compared to Example 3 (and when both are compared to CE1), it is clear that when increasing the IC/Mg ratio from 0.1 to 0.2 the overall yield drops and the XS increases almost to the same level as no IC present. Hence an IC/Mg ratio of 0.1 is preferred over 0.2. When Examples 13 and 14 are compared to Example 3 (and when both are compared to CE1), it is clear that when decreasing the IC/Mg ratio from 0.1 to 0.05 or even 0.025 the overall yield drops and the XS increases almost to the same level as no IC present. Hence an IC/Mg ratio of 0.1 is preferred over 0.05 and 0.025.

An additional advantage of the present invention is an increase in the pore volume and specific surface area of supports and catalysts obtained in the presence of electron donor compounds. This advantage may be useful for the use of the catalysts obtained according to the invention in the process of copolymerization of propylene with other olefins. The increase in pore volume and specific surface, as well as an increase in the activity of catalysts, is achieved by introducing donor compounds as initiator compounds into the support during the support synthesis.

II) Dosage Regimen of IC: Premixing of Grignard and Silane Compounds, Dosing Temperature of 35° C., Dosing Time 5 Hours

### Example 16 (E16)

### Summary

This example makes use of a butyl Grignard compound for the solid support. The support is not activated. As initiator compound an ester compound (di-ester, di butyl phthalate or DBP) is used and as an internal donor di butyl phthalate is used. Steps A), D) and E) were carried as described in Example 1. Step C) is not carried out. Step B is carried out as discussed below. Step B is carried out at a mole ratio DBP/Mg of 0.1, a dosing temperature for the DBP of 35° C. and a dosing time of the DBP of 5 hours.

Step B) Preparation of the Support+Addition of IC

Preparation of the product B (support) was carried out as described in Example 1 except that on the dozing stage the temperature was 35° C. and the dozing time was 5 hour. 300 ml of dibutyl ether was introduced to a 1.5 liter reactor. The reactor was fitted by propeller stirrer and was thermostated at 35° C.

The solution of the product A obtained on step A (450 ml, 0.387 mol Mg) and solution of tetraethoxysilane in DBE (57 ml of TES+168 ml of DBE; Si/Mg=0.66) were cooled to 5° C., and then were dosed simultaneously into reactor throughout mixing device with volume 0.45 ml supplied with a jacket. Dosing time was 300 min. Mixing device (minimixer) was cooled to 5° C. by means of cold water circulating in the device jacket. The contact time of reagents (product A and TES) was 18.7 s in the minimixer and the connecting tube between the minimixer and the reactor. Simultaneously the solution of dibutyl phthalate (DBP) in DBE (10.3 ml of dibutyl phthalate and 39.7 ml of DBE; mole ratio DBP/Mg=0.1) were dosed to reactor through a separate tube during 300 min. The stirring speed in the reactor was 350 rpm at the beginning of dosing and was gradually increased up to 500 rpm at the end of dosing stage.

After completion of the dosing the reaction mixture was heated up to 60° C. during 30 min and kept at this temperature for 1 hour. Then the stirring was stopped and the solid product was allowed to settle. The supernatant was removed by decanting. The solid substance was washed three times using 500 ml of heptane. As a result the solid product B was obtained, suspended in heptane.

### Example 17 (E17)

### Summary

This example makes use of a butyl Grignard compound for the solid support. The support is activated. As initiator compound an ester compound (di-ester, di butyl phthalate or DBP) is used and as an internal donor di butyl phthalate is used. Steps A), D) and E) were carried as described in Example 1. Step C) is carried out according to Example 2. Step B is carried out according to Example 16. Step B is carried out at a mole ratio IC/Mg of 0.1, a dosing temperature for the IC of 35° C. and a dosing time of the IC of 5 hours.

### Example 18 (E18)

### Summary

This example makes use of a butyl Grignard compound for the solid support. The support is activated. As initiator compound an ester compound (di-ester, di butyl phthalate or DBP) is used and as an internal donor di butyl phthalate is used. Steps A), D) and E) were carried as described in Example 1. Step C) is carried out as discussed below. Step B is carried out according to Example 17. Step B is carried out at a mole ratio IC/Mg of 0.1, a dosing temperature for the IC of 35° C. and a dosing time of the IC of 5 hours. This differs from Example 6 by a different support activation.

Step C) Activation of the Support

Support activation of product B was carried out with ethanol and titanium tetraethoxide according to procedure close to procedure described in Ex.4 of EP 1661917A1. The 0.3 l glass flask equipped with a mechanical agitator was filled with a slurry of 6 g of product B dispersed in 100 ml of heptane in inert nitrogen atmosphere at 0° C. Subsequently a solution of 0.96 ml ethanol in 20 ml of heptane was added at 0° C. for 1 hour, resulting in a ratio ethanol/Mg=0.4. The reaction mixture kept at 0° C. for 30 min. Then the temperature was increased to 20° C. and a solution of 0.944 g titanium tetraethoxide (TET/Mg=0.1) in 20 ml of heptane was added for 1 hour. After that the slurry was heated to 30° C. in 30 min and kept at that temperature for another 3 hours.

Finally the supernatant liquid was decanted from the solid reaction product, which was washed once with 150 ml of heptane at 30° C. As a result the product C (activated support) was obtained, suspended in 15 ml of heptane.

### Example 19 (E19)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is not carried out. Step B is carried out as disclosed below. Step B is carried out at a mole ratio EB/Mg of 0.1, a dosing temperature for the EB of 35° C. and a dosing time of the EB of 5 hours.

Step B) Preparation of the Support+Addition of/C

Preparation of the product B (support) was carried out as described in Example 16 except that ethyl benzoate was used instead of dibutyl phthalate (5.3 ml of ethyl benzoate (EB) and 44.7 ml of DBE; mole ratio EB/Mg=0.1).

### Example 20 (E20)

### Summary

This example makes use of a butyl Grignard compound for the solid support. The support is not activated. As initiator compound an ester compound (mono-ester, ethyl benzoate or EB) is used and as an internal donor di butyl phthalate is used. Steps A), D) and E) were carried as described in Example 1. Step C) is carried out according to Example 2. Step B) was carried out as described in Example 18. Step B is carried out at a mole ratio EB/Mg of 0.1, a dosing temperature for the EB of 35° C. and a dosing time of the EB of 5 hours.

### Example 21 (E21)

### Summary

This example makes use of a butyl Grignard compound for the solid support. The support is not activated. As initiator compound a ketone compound (mono-ketone acetone or Ac) is used and as an internal donor di butyl phthalate is used. Steps A), D) and E) were carried as described in Example 1. Step C) is not carried out. Step B) is carried out as discussed below. Step B is carried out at a mole ratio Ac/Mg of 0.1, a dosing temperature for the Ac of 35° C. and a dosing time of the Ac of 5 hours.

Step B) Preparation of the Support+Addition of IC

Preparation of the product B (support) was carried out as described in Example 16 except that acetone was used instead of dibutyl phthalate (2.81 ml of Ac and 47.2 ml of DBE; mole ratio Ac/Mg=0.1).

### Example 22 (E22)

### Summary

This example makes use of a butyl Grignard compound for the solid support. The support is not activated. As initiator compound a ketone compound (acetophenone or AcPh) is used and as an internal donor di butyl phthalate is used. Steps A), D) and E) were carried as described in Example 1. Step C) is not carried out. Step B) is carried out as discussed below. Step B is carried out at a mole ratio AcPh/Mg of 0.1, a dosing temperature for the AcPh of 35° C. and a dosing time of the AcPh of 5 hours.

Step B) Preparation of the Support+Addition of IC Preparation of the product B (support) was carried out as described in Example 16 except that acetophenone was used instead of dibutyl phthalate (4.52 ml of acetophenone (AcPh) and 45.5 ml of DBE; mole ratio AcPh/Mg=0.1).

### Example 23 (E23)

### SUMMARY

This example makes use of a butyl Grignard compound for the solid support. The support is activated. As initiator compound a ketone compound (acetophenone or AcPh) is used and as an internal donor di butyl phthalate is used. Steps A), D) and E) were carried as described in Example 1. Step C) is carried out according to Example 2. Step B) is carried according to Example 22. Step B is carried out at a mole ratio AcPh/Mg of 0.1, a dosing temperature for the AcPh of 35° C. and a dosing time of the AcPh of 5 hours.

### Example 24 (E24)

### SUMMARY

This example makes use of a butyl Grignard compound for the solid support. The support is not activated. As initiator compound an ester compound (di-ester diethylmalonate or DEM) is used and as an internal donor di butyl phthalate is used. Steps A), D) and E) were carried as described in Example 1. Step C) is not carried out. Step B) is carried out as discussed below. Step B is carried out at a mole ratio DEM/Mg of 0.1, a dosing temperature for the DEM of 35° C. and a dosing time of the DEM of 5 hours.

Step B) Preparation of the support+addition of IC

Preparation of the product B (support) was carried out as described in Example 16 except that diethylmalonate was used instead of dibutyl phthalate (6.2 g of diethylmalonate (DEM) and 44 ml of DBE; mole ratio DEM/Mg=0.1).

### Example 25 (E25)

### Summary

This example makes use of a butyl Grignard compound for the solid support. The support is not activated. As initiator compound an ester compound (di-ester diethylsuccinate or DES) is used and as an internal donor di butyl phthalate is used. Steps A), D) and E) were carried as described in Example 1. Step C) is not carried out. Step B) is carried out as discussed below. Step B is carried out at a mole ratio DES/Mg of 0.1, a dosing temperature for the DES of 35° C. and a dosing time of the DES of 5 hours.

Step B) Preparation of the Support+Addition of IC

Preparation of the product B (support) was carried out as described in Example 16 except that diethylsuccinate was used instead of dibutyl phthalate (6.74 g of diethylsuccinate (DES) and 44 ml of DBE; mole ratio DES/Mg=0.1).

### Example 26 (E26)

### Summary

This example makes use of a butyl Grignard compound for the solid support. The support is not activated. As initiator compound a benzamide compound (N,N-dimethyl benzamide or BA) is used and as an internal donor di butyl phthalate is used. Steps A), D) and E) were carried as described in Example 1. Step C) is not carried out. Step B) is carried out as discussed below. Step B is carried out at a mole ratio BA/Mg of 0.1, a dosing temperature for the BA of 35° C. and a dosing time of the BA of 5 hours.

Step B) Preparation of the Support+Addition of IC

Preparation of the product B (support) was carried out as described in Example 16 except that N,N-dimethylbenzamide was used instead of dibutyl phthalate (5.77 g of N,N-dimethylbenzamide (BA) and 45 ml of DBE; mole ratio BA/Mg=0.1).

### Example 27 (E27)

### Summary

This example makes use of a butyl Grignard compound for the solid support. The support is activated. As initiator compound a benzamide compound (N,N-dimethyl benzamide or BA) is used and as an internal donor di butyl phthalate is used. Steps A), D) and E) were carried as described in Example 1. Step C) is carried out according to Example 2. Step B) is carried according to Example 26. Step B is carried out at a mole ratio BA/Mg of 0.1, a dosing temperature for the BA of 35° C. and a dosing time of the BA of 5 hours.

### Example 28 (E28)

### Summary

This example makes use of a butyl Grignard compound for the solid support. The support is not activated. As initiator compound an ester compound (mono-ester butyl acetate or BuAc) is used and as an internal donor di butyl phthalate is used. Steps A), D) and E) were carried as described in Example 1. Step C) is not carried out. Step B) is carried out as discussed below. Step B is carried out at a mole ratio BuAc/Mg of 0.1, a dosing temperature for the BuAc of 35° C. and a dosing time of the BuAc of 5 hours.

Step B) Preparation of the Support+Addition of IC

Preparation of the product B (support) was carried out as described in Example 19 except that butyl acetate was used instead of ethyl benzoate (5.1 ml butyl acetate (BuAc) and 45 ml of DBE; mole ratio BuAc/Mg=0.1).

### Example 29 (E29)

### Summary

This example makes use of a butyl Grignard compound for the solid support. The support is activated. As initiator compound an ester compound (mono-ester butyl acetate or BuAc) is used and as an internal donor di butyl phthalate is used. Steps A), D) and E) were carried as described in Example 1. Step C) is carried out according to Example 2. Step B) is carried according to Example 28. Step B is carried out at a mole ratio BuAc/Mg of 0.1, a dosing temperature for the BuAc of 35° C. and a dosing time of the BuAc of 5 hours.

### Comparative Example 5 (CE5)

### Summary

This example makes use of a butyl Grignard compound for the solid support. The support is not activated. No initiator compound was used. As internal donor an ester compound (di-ester, di butyl phthalate or DBP) is used. Steps A), D) and E) were carried out as described in Example 16, step C was not carried out. Step B) is discussed below.

Step B) Preparation of the Support

Preparation of the solid product B (support) was carried out as described in Example 16, except that dosing of a solution of dibutyl phthalate was not used, that is, the procedure of support syntheses was close to Example I of EP 1 222 214 B1.

### Comparative Example 6 (CE6)

### Summary

This example makes use of a butyl Grignard compound for the solid support. The support is activated. No initiator compound was used. As internal donor an ester compound (di-ester, di butyl phthalate or DBP) is used. Steps A), D) and E) were carried out as described in Example 16, step C was carried out according to Example 2. Step B) was carried out as in Comparative Example 5.

TABLE 2
Examples using a dosing temperature of 35° C. and
time of 5 hours during step B, using DBP as internal donor

| | | | Act. | | | | Yield | | |
|---|---|---|---|---|---|---|---|---|---|
| Ex. | Form# | IC | Sup. | SPAN* | Ti* | Yield* | per Ti* | XS* | BD* |
| E16 | VI | DBP | No | 0.45 | 1.7 | 12.1 | 712 | 1.7 | 455 |
| E17 | VI | DBP | Yes | 0.51 | 1.9 | 18.0 | 947 | 2.3 | 425 |
| E18 | VI | DPB | Yes^{#} | 0.50 | 2.0 | 16.0 | 800 | 3.3 | 440 |
| E19 | III | EB | No | 1.3 | 1.6 | 12.7 | 794 | 2.0 | 475 |
| E20 | III | EB | Yes | 1.2 | 1.7 | 15.3 | 900 | 2.1 | 465 |
| E21 | I | Ac | No | 1.0 | 1.4 | 9.9 | 707 | 1.6 | 458 |
| E22 | I | AcPh | No | 1.0 | 1.7 | 10.9 | 641 | 2.1 | 488 |
| E23 | I | AcPh | Yes | 1.1 | 1.7 | 13.1 | 771 | 2.1 | 459 |
| E24 | IV | DEM | No | 1.6 | 1.7 | 12.7 | 747 | 1.9 | 437 |
| E25 | V | DES | No | 0.8 | 1.4 | 9.3 | 664 | 2.0 | 447 |
| E26 | VII | BA | No | 0.85 | 1.2 | 10.4 | 867 | 1.8 | 470 |
| E27 | VII | BA | Yes | 0.83 | 1.3 | 13.0 | 1000 | 1.8 | 464 |
| E28 | III | BuAc | No | 1.1 | 1.5 | 9.5 | 633 | 2.0 | 427 |
| E29 | III | BuAc | Yes | 0.9 | 1.4 | 11.3 | 807 | 2.0 | 415 |
| CE5 | | None | No | 0.52 | 1.3 | 5.8 | 446 | 2.5 | 460 |
| CE6 | | none | Yes | 0.50 | 2.0 | 11.5 | 575 | 2.6 | 450 |

| | | | Act. | | | | |
|---|---|---|---|---|---|---|---|
| Ex. | Form# | IC | Sup. | PVss* | SAss* | PVp* | SAp* |
| E16 | VI | DBP | No | 0.01 | 1.4 | 0.17 | 155 |
| E17 | VI | DBP | Yes | n.d. | n.d. | 0.19 | 180 |
| E19 | III | EB | No | 0.02 | 9.3 | 0.33 | 198 |
| E22 | I | AcPh | No | 0.016 | 32.4 | n.d. | n.d. |
| E23 | I | AcPh | Yes | n.d. | n.d. | 0.2 | 220 |
| CE5 | | None | No | n.d. | n.d. | 0.13 | 175 |
| CE6 | | none | Yes | n.d. | n.d. | 0.15 | 195 |

^{#}double activation with TET and ETOH

The tables above clearly show that both for the non-activated supports as for the activated support the present invention (addition of IC during support synthesis) achieves at least one of the following: i) an increase in yield, and ii) an increase in yield per wt. % of titanium, iii) an increase in the pore volume and/or surface area of the solid support; and iv) an increase in the pore volume and surface area of the resulting procatalyst.

Other methods of increasing the yield are also known, such as for example from EP 1661917 which the support was activated by ethanol as well as tetra exthoxy titanium. When comparing Example 18 with Example 17 it can be seen that for this procatalyst according to the invention, even with single activation of the support (E17) a similar or even better results are obtained that with a double activated support (E18) in terms of yield and XS. Hence with a simpler solution a similar/better result is obtained. III) Examples using a dosing temperature of 0° C. and time of 2 hours during step B, using different internal donors

### Example 30 (E30)

### Summary

This example makes use of a butyl Grignard compound for the solid support. The support is activated. As initiator compound an ester compound (mono-ester, ethyl benzoate or EB) is used; as an activator to the internal donor ethyl benzoate is used and as internal donor 4-[benzoyl(methyl)-amino]pentan-2-yl benzoate (AB) is used.

Steps A), and E) were carried out as described in Example 1.

Step B is carried out as described in Example 3 except that during the dosing of the components 1.48 ml of ethyl benzoate were used (1.48 ml of EB and 38.5 ml of DBE, mole ratio EB/Mg=0.05). Step C) is carried out according to Example 2.

Step D) Preparation of the procatalyst+activator+ID

Preparation of the procatalyst was carried out using two donors: ethylbenzoate as donor-activator and amino benzoate (AB) as described below. A glass reactor with volume 0.3 l was brought under nitrogen and 100 ml of titanium tetrachloride was added into reactor. The suspension, containing 6 g of the activated solid product B in 15 ml of heptane, was added into reactor under stirring. Reaction mixture kept at the room temperature for 60 min. Then the reaction mixture temperature was started to raise up to 105° C. for 60 min and ethyl benzoate solution (1.68 g in 3 ml of toluene, EB/Mg=0.3) was dosed into reactor for 15 min from 20 to 50° C. Reaction mixture was kept at T=105° C. for 90 min. Then the stirring was stopped and the solid substance was allowed to settle. The supernatant was removed by decanting, after which the solid product was washed with chlorobenzene (120 ml) at 100° C. for 20 min. Then the washing solution was removed by decanting, after which a mixture of titanium tetrachloride (60 ml) and chlorobenzene (60 ml) was added. The reaction mixture was heated up to 105° C. and aminobenzoate solution (0.64 g in 3 ml of toluene, AB/Mg=0.05) was added. Reaction mixture kept at T=105° C. for 60 min. After which the solid substance was allowed to settle, supernatant was removed by decanting and the last treatment was repeated once again, except that 0.57 g AB was used (AB/Mg=0.045).

After that a mixture of titanium tetrachloride (60 ml) and chlorobenzene (60 ml) was added and reaction mixture was kept at T=105° C. for 30 min. The solid substance was allowed to settle, supernatant was removed by decanting and the solid procatalyst obtained was washed five times using 150 ml of heptane at 60° C.

### Example 31 (E31)

### Summary

This example makes use of a butyl Grignard compound for the solid support. The support is activated. As initiator compound an ester compound (mono-ester, ethyl benzoate or EB) is used; as an activator to the internal donor ethyl benzoate is used and as internal donor 4-[benzoyl(methyl)-amino]pentan-2-yl benzoate (AB) is used.

Steps A), and E) were carried out as described in Example 1.

Step B) is carried out as described in Example 3 except that during the dosing of the components 0.74 ml of ethyl benzoate were used (0.74 ml of EB and 39 ml of DBE, mole ratio EB/Mg=0.025).

Step C) is carried out according to Example 2.

Step D is carried out according to Example 30.

### Example 32 (E32)

### Summary

This example makes use of a butyl Grignard compound for the solid support. The support is activated. As initiator compound an ester compound (mono-ester, ethyl acetate or EA) is used; as an activator to the internal donor N,N-dimethyl benzamide (BA-2Me) is used and as internal donor 9,9-bis(methoxymethyl)fluorine (Flu) is used.

Steps A) and E) were carried out as described in Example 1.

Step B) is carried out according to Example 4.

Step C) is carried out according to Example 2.

Step D) is carried out as discussed below.

Step D) Preparation of the Procatalyst+Activator+ID

Preparation of the procatalyst was carried out using two another donors: benzamide (BA-2Me) as donor-activator and fluorene (Flu) as described below. A glass reactor with volume 0.3 l was brought under nitrogen and 120 ml of titanium tetrachloride was added into reactor. The suspension, containing 6 g of the activated solid product B in 15 ml of heptane, was added into reactor under stirring. Reaction mixture kept at the room temperature for 60 min. The reactor was heated to 100° C. and 0.87 g of N,N-dimethylbenzamide (BA-2Me/Mg=0.15 molar ratio) in 2 ml of chlorobenzene was added to reactor. The reaction mixture was kept at 105° C. for 10 min and 1.31 g of 9,9-bis-methoxymethyl-9H-fluorene (flu/Mg=0.132 molar ratio) in 3 ml of chlorobenzene was added to reactor. The reaction mixture was kept at 105° C. for 90 min. Then the stirring was stopped and the solid substance was allowed to settle. The supernatant was removed by decanting, after which the solid product was washed with chlorobenzene (120 ml) at 100° C. for 20 min. Then the washing solution was removed by decanting, after which a mixture of titanium tetrachloride (60 ml) and chlorobenzene (60 ml) was added. The reaction mixture was kept at 105° C. for 60 min, after which the solid substance was allowed to settle. The supernatant was removed by decanting, and the last treatment was repeated twice. The solid substance obtained was washed five times using 150 ml of heptane at 60° C., after which the procatalyst component, suspended in heptane, was obtained.

### Example 33 (E33)

### Summary

This example makes use of a butyl Grignard compound for the solid support. The support is activated. As initiator compound an ester compound (mono-ester, ethyl benzoate or EB) is used; as an activator to the internal donor N,N-dimethyl benzamide (BA-2Me) is used and as internal donor 9,9-bis(methoxymethyl)fluorine (Flu) is used.

Steps A) and E) were carried out as described in Example 1.

Step B) is carried out according to Example 3.

Step C) is carried out according to Example 2.

Step D) is carried out as according to Example 32.

### Example 34 (E34)

### Summary

This example makes use of a butyl Grignard compound for the solid support. The support is activated. As initiator compound an ester compound (mono-ester, ethyl benzoate or EB) is used; as an activator to the internal donor N,N-dimethyl benzamide (BA-2Me) is used and as internal donor Isopropylisopentyldimethoxypropane (IPIPEN) is used. Steps A) and E) were carried out as described in Example 1.

Step B) is carried according to Example 3.

Step C) is carried out according to Example 18.

Step D) is carried out as discussed below.

Step D) Preparation of the Procatalyst+Activator+ID

Preparation of the procatalyst was carried out using two another donors: benzamide (BA-2Me) as donor-activator and isopropylisopentyldimethoxypropane (IPIPEN) as described below. A glass reactor with volume 0.3 l was brought under nitrogen and 138 ml of titanium tetrachloride was added into reactor. The suspension, containing 5.5 g of the activated solid product B in 10 ml of heptane, was added into reactor under stirring. Reaction mixture kept at the room temperature for 60 min. The reactor was heated to 100° C. and 0.96 g of N,N-dimethylbenzamide (BA-2Me/Mg=0.16 molar ratio) in 3 ml of chlorobenzene was added to reactor. The reaction mixture was kept at 100° C. for 10 min and 0.61 g of isopropylisopentyldimethoxypropane (IPIPEN/Mg=0.074 molar ratio) in 3 ml of chlorobenzene was added to reactor. The reaction mixture was kept at 100° C. for 90 min. Then the stirring was stopped and the solid substance was allowed to settle. The supernatant was removed by decanting, after which the solid product was washed with chlorobenzene (138 ml) at 100° C. for 20 min. Then the washing solution was removed by decanting, after which a mixture of titanium tetrachloride (69 ml) and chlorobenzene (69 ml) was added. Then 0.55 g of isopropylisopentyldimethoxypropane (IPIPEN/Mg=0.061 molar ratio) in 3 ml of chlorobenzene was added to reactor. The reaction mixture was kept at 105° C. for 60 min, after which the solid substance was allowed to settle. The supernatant was removed by decanting, a mixture of titanium tetrachloride (69 ml) and chlorobenzene (69 ml) was added and the reaction mixture was kept at 105° C. for 60 min. After this solid substance was allowed to settle, the supernatant was removed by decanting and the last treatment was repeated one more time. The solid substance obtained was washed five times using 150 ml of heptane at 60° C., after which the procatalyst component, suspended in heptane, was obtained.

### Comparative Example 7 (CE7)

### Summary

This example makes use of a butyl Grignard compound for the solid support. The support is activated. No initiator compound was used; as an activator to the internal donor ethyl benzoate is used and as internal donor 4-[benzoyl(methyl)-amino]pentan-2-yl benzoate (AB) is used.

Steps A) and E) were carried out as described in Example 1.

Step B) is carried out according to Comparative Example 1.

Step C) is carried out according to Example 2.

Step D) is carried out according to Example 30.

### Comparative Example 8 (CE8)

### Summary

This example makes use of a butyl Grignard compound for the solid support. The support is activated. No initiator compound was used; as an activator to the internal donor N,N-dimethyl benzamide (BA-2Me) is used and as internal donor 9,9-bis(methoxymethyl)fluorine (Flu) is used.

Steps A) and E) were carried out as described in Example 1.

Step B) is carried out according to Comparative Example 1.

Step C) is carried out according to Example 2.

Step D) is carried out according to Example 32.

### Comparative Example 9 (CE9)

### Summary

This example makes use of a butyl Grignard compound for the solid support. The support is activated. No initiator compound was used; as an activator to the internal donor N,N-dimethyl benzamide (BA-2Me) is used and as internal donor isopropylisopentyldimethoxypropane (IPIPEN) is used.

Steps A) and E) were carried out as described in Example 1.

Step B) is carried out according to Comparative Example 1.

Step C) is carried out according to Example 18.

Step D) is carried out according to Example 34.

TABLE 3
Examples using a dosing temperature of 0° C. and time
of 2 hours during step B, using different internal donors

| | | IC | ID | Act. | | | Yield | | |
|---|---|---|---|---|---|---|---|---|---|
| Ex. | Form# | [IC/Mg] | [Act] | Sup. | Ti | Yield | per Ti | XS | BD |
| E30 | III | EB[0.05] | AB [EB] | Yes | 3.2 | 11.4 | 356 | 2.6 | 480 |
| E31 | III | EB[0.025] | AB [EB] | Yes | 2.9 | 12.0 | 414 | 2.5 | 486 |
| E32 | III | EA[0.1] | Flu [Ba2—Me] | Yes | 2.2 | 13.2 | 600 | 1.9 | 405 |
| E33 | III | EB[0.1] | Flu [Ba2—Me] | Yes | 2.5 | 10.9 | 436 | 1.9 | 470 |
| E34 | III | EB[0.1] | IPIPEN [Ba2—Me] | Yes | 2.4 | 15.2 | 633 | 1.6 | 470 |
| CE7 | | none | AB [EB] | Yes | 3.2 | 11.2 | 350 | 2.5 | 470 |
| CE8 | | none | Flu [Ba2—Me] | Yes | 2.8 | 11.4 | 407 | 1.7 | 475 |
| CE9 | | none | IPIPEN [Ba2—Me] | Yes | 3.1 | 13.2 | 426 | 1.7 | 469 |

| | | IC | ID | Act. | | | |
|---|---|---|---|---|---|---|---|
| Ex. | Form# | [IC/Mg] | [Act] | Sup. | SPAN | PVp | SAp |
| E30 | III | EB[0.05] | AB [EB] | Yes | 0.9 | 0.21 | 430 |
| E31 | III | EB[0.025] | AB [EB] | Yes | 0.8 | 0.19 | 440 |
| E32 | III | EA[0.1] | Flu [Ba2—Me] | Yes | 0.82 | 0.31 | 287 |
| E33 | III | EB[0.1] | Flu [Ba2—Me] | Yes | 0.80 | 0.20 | 350 |
| E34 | III | EB[0.1] | IPIPEN [Ba2—Me] | Yes | 0.5 | 0.22 | 340 |
| CE7 | | none | AB [EB] | Yes | 0.5 | 0.14 | 230 |
| CE8 | | none | Flu [Ba2—Me] | Yes | 0.6 | 0.14 | 220 |
| CE9 | | none | IPIPEN [Ba2—Me] | Yes | 0.7 | 0.14 | 230 |

The table above clearly shows an increase in the pore volume and surface area of the resulting procatalyst, making those procatalysts very suitable for homo but also hetero-polymer as it require to be more porous in order to be more accessible to the different monomers.

Therefore, those procatalysts are very suitable to obtain co-polymer or terpolymers of polypropylene, with for example higher ethylene/rubber content.

1. A process for the preparation of a solid support for a procatalyst suitable for preparing a catalyst composition for olefin polymerization, said process comprising:
A) providing or preparing a compound R⁴_{z}MgX⁴_{2-z} wherein: R⁴ is independently a linear, branched or cyclic hydrocarbyl group independently selected from alkyl, alkenyl, aryl, aralkyl, or alkylaryl groups, or one or more combinations thereof; X⁴ is independently fluoride, chloride, bromide or iodide; and 0<z<2; and
B) contacting the compound R⁴_{z}MgX⁴_{2-z} with a silane compound Si(OR⁵)₄₋ₙ(R⁶)ₙ to form a Mg(OR¹)ₓX¹₂₋ₓ wherein: R¹, R⁵ and R⁶ are each independently a linear, branched or cyclic hydrocarbyl group independently selected from alkyl, alkenyl, aryl, aralkyl, alkoxycarbonyl or alkylaryl groups, or one or more combinations thereof;
X¹ is independently fluoride, chloride, bromide or iodide; n is in range of 0 to 4; 0<z<2; and 0<x<2;
wherein an initiator compound, which is a ketone, a diketone, an ester, a diester, or a benzamide, is added during step B to obtain a solid support,
wherein the initiator compound does not contain any heteroatom, nor is a phthalate.

2. The process according to claim 1, wherein the initiator compound is a ketone compound represented by Formula I or a diketone represented by Formula II, 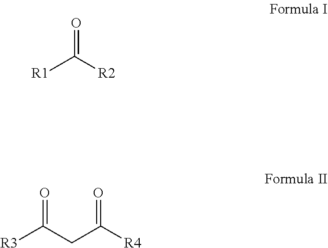
wherein R1, R2, R3, and R4 are each independently a linear, branched or cyclic hydrocarbyl group, which hydrocarbyl group is independently selected from alkyl, alkenyl, aryl, aralkyl, or one or more combinations thereof.

3. The process according to claim 1, wherein the initiator compound is a mono ester represented by Formula III or a diester represented by Formulas IV, or V 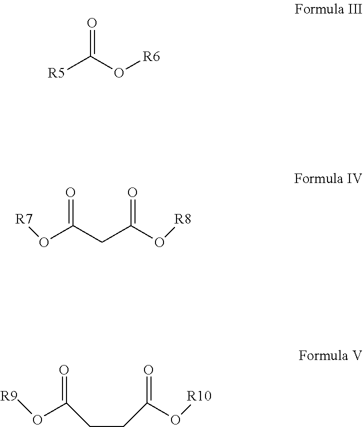
wherein R5, R6, R7, R8, R9 and R10, are each independently a linear, branched or cyclic hydrocarbyl group, which hydrocarbyl group is independently selected from alkyl, alkenyl, aryl, aralkyl, or one or more combinations thereof.

4. The process according to claim 1, wherein the initiator compound is an amide represented by Formula VII 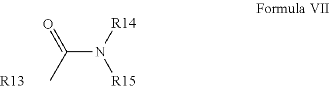
wherein R13, R14, and R15 are each independently a linear, branched or cyclic hydrocarbyl group, which hydrocarbyl group is independently selected from alkyl, alkenyl, aryl, aralkyl, or one or more combinations thereof.

5. The process according to claim 1, further comprising:
C) activating the solid support obtained in B) by contacting the solid support obtained with an activating electron donor and/or an activating compound.

6. A solid support directly obtained by or obtainable by the process according to claim 1.

7. A process for the preparation of a procatalyst suitable for preparing a catalyst composition for olefin polymerization, said process comprising:
I) providing a solid support or activated solid support according to claim 6; and
II) reacting said solid support or activated solid support with a halogen-containing Ti-compound, optionally an activator prior to or simultaneously with the addition of an internal donor, and at least one internal electron donor to obtain said procatalyst.

8. The process according to claim 7, wherein during II) as activator and internal electron donor are added:
N,N-dimethyl benzamide (BA-2Me) as activator and 9,9-bis(methoxymethyl)fluorene (Flu) as internal donor; or
ethyl benzoate (EB) as activator and 4-[benzoyl(methyl)-amino]pentan-2-yl benzoate (AB) as internal donor, or
N,N-dimethyl benzamide (BA-2Me) as activator and Isopropylisopentyldimethoxypropane (IPIPEN) as internal donor.

9. A procatalyst directly obtained by or obtainable by the process according to claim 7.

10. The solid support or activated solid support according to claim 6, having an average particle size (or APS) of between 8 and 35 microns.

11. A catalyst system comprising a procatalyst according to claim 10, a co-catalyst and optionally at least one external electron donor.

12. A process for the preparation of polyolefins comprising the contacting of the catalyst system of claim 11 with at least one olefin, to prepare a polypropylene homopolymer or a mixture of propylene and at least one olefin, to prepare a propylene-olefin copolymer.

13. A polyolefin obtainable by the process according to claim 12.

14. A shaped article comprising the polyolefin according to claim 13.
